(19) United States
(12) Patent Application Publication
(10) Pub. No.: US 2011/0273658 A1
(43) Pub. Date: Nov. 10, 2011

(54) POLARIZATION SPLIT ELEMENT AND METHOD FOR MANUFACTURING THE SAME

(75) Inventors: Eiji Koyama, Ibaraki-shi (JP); Tomonori Kanai, Ibaraki-shi (JP); Masaki Mukoh, Ibaraki-shi (JP)

(73) Assignee: HITACHI MAXELL, LTD., Ibaraki-shi, Osaka (JP)

(21) Appl. No.: 13/143,434

(22) PCT Filed: Mar. 5, 2010
(86) PCT No.: PCT/JP2010/053671

§ 371 Date: Jul. 6, 2011

(30) Foreign Application Priority Data
Apr. 13, 2009 (JP) 2009-097112

(51) Int. Cl. G02F 1/13; G02F 1/1335

(52) U.S. Cl. 349/187; 349/194

(57) ABSTRACT

Grating grooves of a predetermined shape are filled with a polymerizable liquid crystal, and thereafter, the polymerizable liquid crystal is cured to form a striped structure including a uniaxial polymer liquid crystal having an alignment orientation identical to the longitudinal direction of the grating grooves, without using a liquid crystal alignment film. Consequently, it is possible to stably and effectively align the polymer liquid crystal without using an alignment film and to adjust the film thickness easily, whereby a polarization splitting element exhibiting a high and uniform split efficiently can be obtained stably.

### TECHNICAL FIELD

The present invention relates to a splitting element and a method for manufacturing the same.

### BACKGROUND

Conventionally, in a polarization splitting element using a polymer liquid crystal, a polyimide resin is applied on a pair of transparent substrates and cured with heat, which is treated thereafter for alignment by buffing so as to form a liquid crystal alignment film. Subsequently, the space between the substrates is filled with a polymerizable liquid crystal material, and the polymerizable liquid crystal material is exposed to light via a photo-mask at temperature where the polymerizable liquid crystal is in a liquid crystal state, thereby forming a grating. Later, the temperature is raised to a point where the polymerizable liquid crystal turns to isotropic to crosslink the uncured polymerizable liquid crystal. In this manner, a polymer liquid crystal thin film formed with a grating of a predetermined shape is manufactured, and a diffraction grating having an optical anisotropy is formed.

However in this method where the alignment state of the polymerizable liquid crystal is obtained by use of the formed alignment film, it is difficult to control stably the alignment state. Another problem is that a washing step after the buffing cannot be omitted.

### PROBLEM TO BE SOLVED

Therefore, with the foregoing in mind, the invention relates to a splitting element using a polymer liquid crystal thin film and a method for manufacturing the same, for solving the above-mentioned problems in the conventional technique.

### MEANS FOR SOLVING PROBLEM

In embodiments, a polarization splitting element is characterized in that it includes an arrangement of a striped structure of a uniaxial polymer liquid crystal, wherein the striped structure of the uniaxial polymer liquid crystal is formed in an isotropic medium, and an optical axis of the polymer liquid crystal matches with the longitudinal direction of the striped structure.

Further, in embodiments, a first method for manufacturing a polarization splitting element includes: filling grooves of a predetermined shape formed in a medium with a polymerizable liquid crystal; and curing the polymerizable liquid crystal so as to form a polymer liquid crystal grating where an optical anisotropic axis is aligned in the longitudinal direction of the grooves.

In embodiments, a second method for manufacturing a polarization splitting element includes: filling grooves of a predetermined shape formed on a transfer mold with a polymerizable liquid crystal; curing the polymerizable liquid crystal so as to form a polymer liquid crystal; transferring the polymer liquid crystal onto a substrate by use of an isotropic medium; and filling grating interstices formed of the polymer liquid crystal with an isotropic medium.

In embodiments, by employing the configuration of a splitting element and the method for manufacturing the same, it is possible to stably and effectively align the polymer liquid crystal without using any particular alignment film and to adjust the film thickness easily, whereby a polarization splitting element exhibiting a high and uniform split efficiently can be obtained stably.

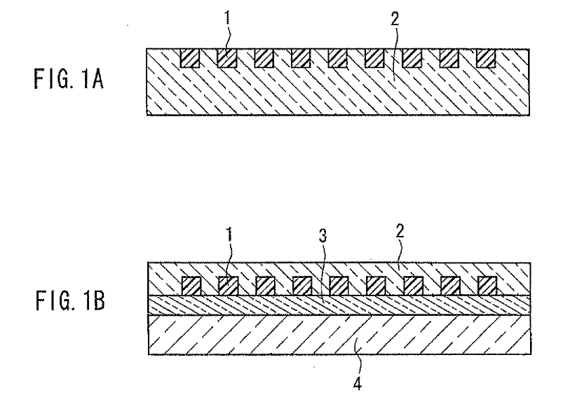

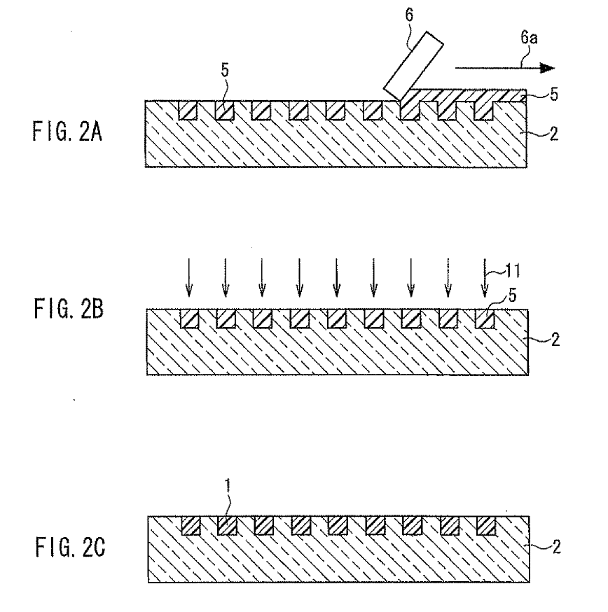

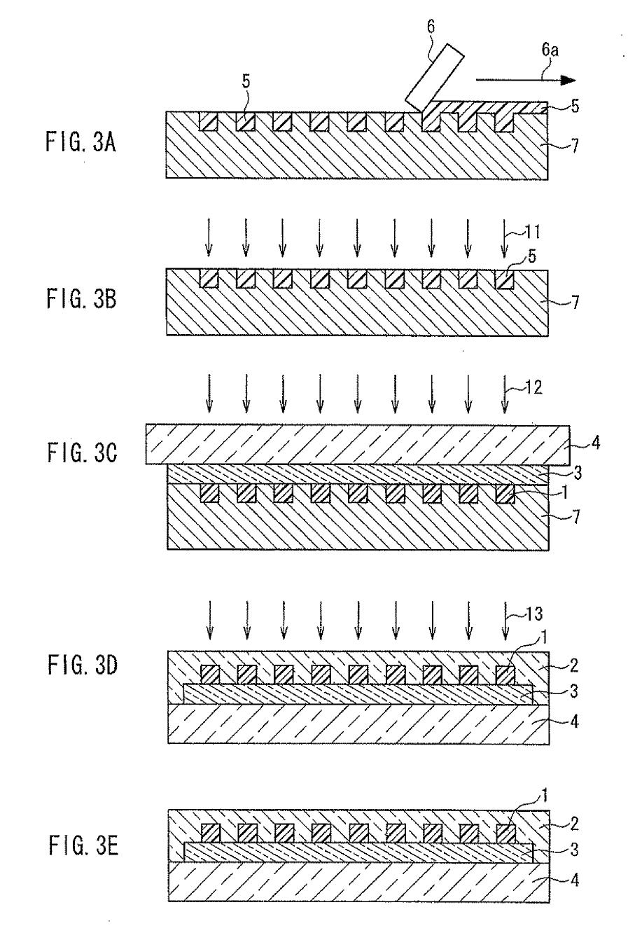

### BRIEF DESCRIPTION OF DRAWINGS

[FIG. 1] FIGS. 1A and 1B respectively are side cross-sectional views showing an example of a polarization splitting element according to the present invention. FIG. 1A is a side cross-sectional view showing a polarization splitting element manufactured by forming a polymer liquid crystal in grooves formed as recesses on a substrate surface. FIG. 1B is a side cross-sectional view showing a polarization splitting element with a polymer liquid crystal layer transferred onto a substrate.

[FIG. 2] In embodiments, FIGS. 2A-2C are cross-sectional views showing an example of a process for manufacturing a polarization splitting element, FIG. 2A is a side cross-sectional view showing a step of filling grooves formed as recesses on a substrate with a liquefied polymerizable liquid crystal. FIG. 2B is a side cross-sectional view showing a step of polymerizing and curing the filled polymerizable liquid crystal with ultraviolet light so as to form a polymer liquid crystal, and FIG. 2C is a side cross-sectional view showing a structure of the thus manufactured polarization splitting element.

[FIG. 3] In embodiments, FIGS. 3A-3E are side cross-sectional views showing another example of a process for manufacturing a polarization splitting element. FIG. 3A is a side cross-sectional view showing a step of filling grooves formed as recesses on a mold with a liquefied polymerizable liquid crystal. FIG. 3B is a side cross-sectional view showing a step of polymerizing and curing the filled polymerizable liquid crystal with ultraviolet light so as to form a polymer liquid crystal. FIG. 3C is a side cross-sectional view showing a step of laminating a liquefied ultraviolet curable resin and a glass plate on the mold filled with the polymer liquid crystal, polymerizing and curing the ultraviolet curable resin with ultraviolet light so as to form a transparent isotropic medium that is used then for transferring the polymer liquid crystal onto a substrate. FIG. 3D is a side cross-sectional view showing a step of applying a liquefied ultraviolet curable resin on the polymer liquid crystal grating transferred on the substrate via the transparent isotropic medium, and polymerizing and curing the ultraviolet curable resin with ultraviolet light so as to form another transparent isotropic medium. And FIG. 3E is a side cross-sectional view showing a structure of the thus manufactured polarization splitting element.

### DETAILED DESCRIPTION

To solve the above-mentioned problems, in embodiments, grooves that have been formed to have a predetermined shape are filled with a polymerizable liquid crystal. The polymerizable liquid crystal is aligned spontaneously in the longitudinal direction of the grooves due to the interaction between the groove side wall surfaces and the liquid crystal molecules, without any particular alignment treatment. Subsequently, the polymerizable liquid crystal is polymerized while maintaining the aligned state, thereby providing a polymer liquid crystal. In this manner, the alignment orientation of the polymer liquid crystal can be controlled with a high accuracy in the longitudinal direction of the grooves via no liquid crystal alignment film. At the same time, the thickness of the liquid crystal layer can be controlled by the depth of the grooves that have been formed.

The polymerizable liquid crystal for forming the polymer liquid crystal grating used in embodiments is a composition of a reactive compound or the like such as a monomer and oligomer exhibiting liquid crystallinity.

Methods of curing a polymerizable liquid crystal include irradiation of light such as visible light and UV (ultraviolet) light, and heating. A curing method through light irradiation is preferred, since the method is restricted less by the phase shift temperature of the polymerizable liquid crystal. Therefore, the following explanation refers to a case of polymerizing and curing a polymerizable liquid crystal by irradiation of light. In the present specification, for convenience in distinction, “polymerizable liquid crystal” indicates a liquid crystal in non-polymerized state and a “polymer liquid crystal” indicates a polymerized liquid crystal.

FIGS. 1A and 1B show an example of a structure of a polarization splitting element including a polymer liquid crystal grating according to the present invention.

FIG. 1A is a cross-sectional view showing an example of a polarization splitting element of the present invention. In FIG. 1A, numeral 1 denotes a grating of a polymer liquid crystal, and 2 denotes a substrate of an isotropic medium. In this configuration, grooves that have been formed as recesses of predetermined shape on the substrate 2 are filled with a polymerizable liquid crystal. Thereby, the liquid crystal molecules are aligned spontaneously along the longitudinal direction of the grooves due to the molecular interaction between the groove wall surfaces and the liquid crystal, and thus the liquid crystal can be aligned along the longitudinal direction of the grooves without subjecting the substrate surface to any particular alignment treatment. By curing the polymerizable liquid crystal in this state, a polarization splitting element having an optical anisotropy can be manufactured stably.

For the substrate 2 used in this configuration, an isotropic medium having a refractive index equal to either the ordinary light refractive index (nₒ) or the extraordinary light refractive index (nₑ) of the polymer liquid crystal is desirable from the viewpoint of enhancing the polarization splitting performance relying on the orientation of the linear polarization of incident light.

Examples of the substrate 2 include a transparent plate of glass or plastics, and a so-called 2P (Photo Polymer) substrate. The 2P substrate is prepared by applying on a glass substrate an ultraviolet curable resin based on an acrylic radical polymerization monomer on which recesses are then transferred. Plastics are preferred from the viewpoint of mass productivity and easiness in groove formation, and a glass plate is preferred from the viewpoint of its excellent hardness and durability.

The 2P substrate is preferred from the viewpoint of easy matching with the liquid crystal layer in the refractive indices, since only the refractive index of the cured UV resin on which the grooves are formed is required to match with the refractive index of the polymer liquid crystal. Further, the surface of the substrate having recesses may be treated for improving the adhesiveness, as required.

A preferred example of the polymerizable liquid crystal is prepared by providing a polymeric functional group such as acrylic and epoxy, at the end of a mesogenic group that exhibits a liquid crystal state. The most preferred one is nematic in a liquid crystal state before polymerization.

FIG. 1B is a cross-sectional view showing another example of a polarization splitting element of the present invention. As shown in this figure, a grating made of a polymer liquid crystal 1 can be coated with another transparent isotropic medium 3. Numeral 4 denotes a transparent substrate made of glass, plastics or the like.

For the isotropic medium 3, an ultraviolet curable resin is most preferred. In particular, in a case where an acrylic modification type polymer liquid crystal is used as the polymerizable liquid crystal for forming the polymer liquid crystal 1, an acrylic ultraviolet curable resin may be used for the isotropic medium 3, so that a strong adhesion is provided between the polymer liquid crystal 1 and the isotropic medium 3.

For an isotropic medium 2 enveloping the polymer liquid crystal 1 after polymerization, an isotropic medium that has a refractive index equal to either the ordinary light refractive index (nₒ) or the extraordinary light refractive index (nₑ) of the polymer liquid crystal thin film is preferable from the viewpoint of enhancing the polarization splitting performance relying on the orientation of the linear polarization of incident light. For the isotropic medium 2, for example, an acrylic resin, epoxy-based resin or the like of photopolymerization type can be used.

The materials of the isotropic mediums 2 and 3 may be different from each other or identical to each other.

The polarization splitting element of the present invention is not limited to those as shown in FIGS. 1A and 1B. For example, the polarization splitting element of the present invention may be sandwiched with other transparent members or laminated together with other optical members.

In the above-mentioned configuration of the present invention, since the liquid crystal molecules are aligned spontaneously in parallel to the grooves due to the interaction with the wall surfaces of the grooves, the optical axis of the polymer liquid crystal becomes parallel to the longitudinal direction of the grooves.

The effect is achieved irrespective of the cross-sectional shape of the grooves, namely, the cross section can be shaped rectangular, triangular, semicircular or the like. Therefore, any appropriate shape can be selected in accordance with the application. For an application as a diffraction grating, a rectangle or a triangle is preferred.

Further, as the alignment of the liquid crystal layer occurs due to the interaction between the liquid crystal molecules and the wall surfaces of the grooves in the configuration of the present invention, the optical axis of the formed polymer liquid crystal is limited to the longitudinal direction of the grooves. This does not cause any restriction for use as a polarization splitting element. On the contrary, an advantage is provided, namely for example, by forming in one element a plurality of regions whose grooves are directed differently, a plurality of regions on which polymer liquid crystal gratings having alignment directions different from each other can be formed easily. However in this case, depending on the polarization directions of the incident polarized light, a polymer liquid crystal grating that does not diffract the polarized light and a polymer liquid crystal grating that completely diffracts the polarized light are limited respectively.

The polarization splitting element of the present invention is not limited to the optical transparent type element as described above, but it can be applied also to a reflection type element.

### EXAMPLES

Hereinafter, examples of the present invention will be described with reference to the attached drawings.

### Example 1

An example of the polarization splitting element as shown in FIG. 1A will be described. FIGS. 2A-2C are side cross-sectional views showing respective processes of a first method for manufacturing a polarization splitting element having an arrangement of a striped structure of a polymer liquid crystal.

For a substrate 2, a glass substrate on which an ultraviolet curable resin layer having a plurality of grooves each having a width of 10 μm, a pitch of 20 μm and a depth of 8 μm and parallel to each other was used (the glass substrate is not shown in FIGS. 2A-2C). This substrate 2 was prepared by a so-called 2P method including steps of applying a liquefied ultraviolet curable resin on an Ni—P electroless plated mold that had been machined to form grooves; laminating a glass substrate thereon; subsequently curing the ultraviolet curable resin by ultraviolet irradiation so as to transfer the groove shape onto the ultraviolet curable resin; and peeling off the glass substrate and the ultraviolet curable resin layer together. For providing the ultraviolet curable resin, 20 weight parts of dicyclopentadienyl hexaacrylate (supplied by Kyoeisha Chemical Co., Ltd.) was mixed with 80 weight parts in total of isobornyl acrylate (supplied by Kyoeisha Chemical Co., Ltd.) and phenoxy acrylate (supplied by Kyoeisha Chemical Co., Ltd.) as a refractive index regulator, and 3 weight parts of IRGACURE 184 (supplied by Ciba Speciality Chemicals) as an initiator, so that the mixture would have a refractive index of 1.525 when cured.

First, as shown in FIG. 2A, RMS03-001C (supplied by Merck & Co., Inc.) as a liquefied polymerizable liquid crystal 5 was dropped on a surface of the substrate 2, namely a surface having recesses, the solvent was dried with heat and then the temperature was lowered again to the room temperature. Later, the surface of the substrate 2 was leveled with a squeegee 6, so that the excessive polymerizable liquid crystal squeezing out of the grooves on the substrate 2 was removed to flatten the surface. The arrow 6a denotes the moving direction of the squeegee 6.

In this state, as shown in FIG. 2B, the polymerizable liquid crystal 5 was reacted and cured by irradiation of ultraviolet light 11 having a main wavelength of 365 nm, thereby providing a polarization splitting element as shown in FIG. 2C.

The alignment state of the polymer liquid crystal 1 having a striped structure was observed with a polarization microscope. Through the observation, it was confirmed that a preferable alignment was obtained, since the molecular axis of the polymer liquid crystal grating was aligned in the stripe direction (groove direction).

The alignment state of the liquefied polymerizable liquid crystal 5 was observed with a polarization microscope just after dropping on the substrate 2, and after filling the grooves by use of the squeegee 6. Any strong alignment state was not found just after the dropping. On the other hand, after filling the grooves by use of the squeegee 6, a strong alignment parallel to the longitudinal direction of the grooves was observed. The reason can be considered as follows. Since the liquid crystal molecules have a property to be aligned parallel to the wall surface of the substrate 2, in a groove enclosed by a plurality of wall surfaces, the liquid crystal molecules were aligned spontaneously in a direction parallel to the groove.

It is difficult to make only the polymerizable liquid crystal remain within the grooves at the time of squeezing, and a slight amount of polymerizable liquid crystal would remain on the flat parts between grooves. However, since the polymerizable liquid crystal at the parts is free from the strong alignment control by the grooves, the polymerizable liquid crystal will be aligned randomly. Furthermore, the polymerizable liquid crystal is extremely thin. Therefore, the polymerizable liquid crystal at the parts does not impose any substantial influence on the polarization state of the formed grating.

The obtained polarization splitting element was irradiated with a polarized red laser beam. In a case where the polarization direction was matched with the stripe direction (groove direction) of the polymer liquid crystal 1, the intensity of the diffraction light changes considerably with respect to the orthogonal direction, as having been confirmed visually. As a result, it was confirmed that embodiments of the invention provide a more preferable polarized diffracted light.

Here, the ordinary light refractive index of the cured RMS03-001C is 1.529 and the extraordinary light refractive index is 1.684. The refractive index of the ultraviolet curable resin enveloping the polymer liquid crystal is set to be lower than any of the above-described values, because the polymerizable liquid crystal in the grooves will undergo volumetric shrinkage at the time of curing and the film thickness will be changed.

### Example 2

An example of the polarization splitting element as shown in FIG. 1B will be described. FIGS. 3A-3C are side cross-sectional views showing respective processes of a second method for manufacturing a polarization splitting element having an arrangement of a striped structure of polymer liquid crystal.

In this example, first as shown in FIG. 3A, RMS03-001C (supplied by Merck & Co., Inc.) as a polymerizable liquid crystal 5 was dropped on a mold 7 on which a plurality of grooves each having a width of 10 μm, a pitch of 20 μm and a depth of 8 μm and parallel to each other had been formed. The solvent was dried with heat and then the temperature was lowered again to the room temperature. Later, the surface of the mold 7 was leveled with a squeegee 6, so that the excessive polymerizable liquid crystal squeezing out of the grooves on the mold 7 was removed to flatten the surface of the mold 7. The arrow 6a denotes the moving direction of the squeegee 6. The mold 7 used here had an Ni—P electroless plated surface that had been machined to form grooves.

In this state, as shown in FIG. 3B, the polymerizable liquid crystal 5 was reacted and cured by irradiation of ultraviolet light 11 having a main wavelength of 365 nm.

Next, as shown in FIG. 3C, a liquefied ultraviolet curable resin was applied on the mold 7 having grooves filled with the polymer liquid crystal 1, on which a glass substrate 4 of KBM-503 (supplied by Shin-Etsu Chemical Co., Ltd.) having a thickness of 0.5 mm and having an adhesion enhancing film (not shown) was laminated. The ultraviolet curable resin was reacted and cured by irradiation of ultraviolet light 12 having a main wavelength of 365 nm. For providing the liquefied ultraviolet curable resin, 20 weight parts of dicyclopentadienyl hexaacrylate (supplied by Kyoeisha Chemical Co., Ltd.) was mixed with 80 weight parts in total of isobornyl acrylate (supplied by Kyoeisha Chemical Co., Ltd.) and phenoxy acrylate (supplied by Kyoeisha Chemical Co., Ltd.) as a refractive index regulator, and 3 weight parts of fRGACURE 184 (supplied by Ciba Speciality Chemicals) as an initiator, so that the mixture would have a refractive index of 1.53 when cured.

At this stage, since a transparent isotropic medium 3 made of the cured ultraviolet curable resin adheres strongly to the polymer liquid crystal 1, it is possible to transfer the grating of the polymer liquid crystal 1 onto the glass substrate 4.

Later, the grating made of the polymer liquid crystal 1 integrated with the glass substrate 4 via the isotropic medium 3 was peeled off from the mold 7. Then, as shown in FIG. 3D, another liquefied ultraviolet curable resin was applied on the surface of the polymer liquid crystal 1 on the isotropic medium 3, which was irradiated with ultraviolet light 13 having a main wavelength of 365 nm, thereby reacting and curing the ultraviolet curable resin so as to form an isotropic medium 2 of a transparent resin. In this manner, the polarization splitting element as shown in FIG. 3E was formed. For providing the ultraviolet curable resin composing the isotropic medium 2, 20 weight parts of 1,6 hexyldiacrylate (supplied by Kyoeisha Chemical Co., Ltd.) was mixed with 80 weight parts in total of hydroxybutyl methacrylate (supplied by Kyoeisha Chemical Co., Ltd.) and 2-hydroxy-3-phenoxypropyl acrylate (supplied by Kyoeisha Chemical Co., Ltd.) as a refractive index regulator, and 3 weight parts of IRGACURE 184 (supplied by Ciba Speciality Chemicals) as an initiator, so that the mixture would have a refractive index of 1.53 when cured.

The alignment state of the polymer liquid crystal 1 having a striped structure was observed with a polarization microscope. Through the observation, it was confirmed that a preferable alignment was obtained since the molecular axes of the polymer liquid crystal gratings were aligned in the stripe direction.

The obtained polarization splitting element was irradiated with a polarized red laser beam. In a case where the polarization direction was matched with the stripe direction of the polymer liquid crystal 1, the intensity of the diffraction light changes considerably with respect to the orthogonal direction, as having been confirmed visually. As a result, it was confirmed that embodiments of the invention provide a more preferable polarized diffracted light.

### EXPLANATION OF LETTERS AND NUMERALS

1: polymer liquid crystal
2: isotropic medium (substrate)
3: isotropic medium
4: transparent substrate
5: polymerizable liquid crystal
6: squeegee
7: mold

1. A polarization splitting element comprising an arrangement of a striped structure of a uniaxial polymer liquid crystal, wherein the striped structure of the uniaxial polymer liquid crystal is formed in an isotropic medium, and an optical axis of the polymer liquid crystal matches with the longitudinal direction of the striped structure.

2. The polarization splitting element according to claim 1, wherein the polymer liquid crystal and the isotropic medium are in direct contact with each other via no liquid crystal alignment film.

3. A method for manufacturing a polarization splitting element, comprising:
filling grooves of a predetermined shape formed in a medium with a polymerizable liquid crystal; and
curing the polymerizable liquid crystal so as to form a polymer liquid crystal grating where an optical anisotropic axis is aligned in the longitudinal direction of the grooves.

4. A method for manufacturing a polarization splitting element, comprising:
filling grooves of a predetermined shape formed on a transfer mold with a polymerizable liquid crystal;
curing the polymerizable liquid crystal so as to form a polymer liquid crystal;
transferring the polymer liquid crystal onto a substrate by use of an isotropic medium; and
filling grating interstices formed of the polymer liquid crystal with an isotropic medium.
